(19) United States
(12) Patent Application Publication
(10) Pub. No.: US 2021/0266636 A1
(43) Pub. Date: Aug. 26, 2021

(54) EVALUATING THE USAGE BEHAVIOR OF A USER OF A PORTABLE WIRELESS COMMUNICATION DEVICE IN A MEANS OF TRANSPORTATION

(71) Applicant: BAYERISCHE MOTOREN WERKE AKTIENGESELLSCHAFT, Munich (DE)

(72) Inventor: Mikhail SMIRNOV, Andechs (DE)

(21) Appl. No.: 17/252,363

(22) PCT Filed: Jul. 3, 2019
(86) PCT No.: PCT/DE2019/100621

§ 371 Date: Dec. 15, 2020

(30) Foreign Application Priority Data
Aug. 1, 2018 (DE) 10 2018 212 811.1

(51) Int. Cl. H04N 21/442; H04N 21/414; H04N 21/439; H04N 21/44

(52) U.S. Cl. CPC H04N 21/44204; H04N 21/41407; H04N 21/43637; H04N 21/4394; H04N 21/44008; H04N 21/41422

(57) ABSTRACT

A server (11), a means of transport (10) and a method for evaluating a usage behavior of a user of a portable wireless communication device (1) in a means of transport (10) are proposed. The method comprises the following steps:

operating the wireless communication device in connection with the means of transport (10) in a screen mirroring method, hereinafter referred to as “projected mode”,

analyzing a content originating from the wireless communication device (1) by means of

a graphical object recognition algorithm, and/or

an acoustic pattern recognition algorithm

by the means of transport (10) and

determining the usage behavior of the user based on the analysis result.

The present invention relates to a server, a means of transport and a method for evaluating the usage behavior of a user of a portable wireless communication device in a means of transport. In particular, the present invention relates to the extension of the evaluation of a usage behavior of the user to cases in which the portable wireless communication device is operated in a so-called “projected mode”.

In order to improve the user-friendliness of user interfaces and graphical user interfaces, it is known in the prior art to use analysis software during the operation of the user interface by the user in order to detect and report operating steps and possible problems of the user when operating the user interface. The collected data may be used by developers to address the problems encountered and to modify the software/hardware of the user interface accordingly.

In addition, screen mirroring methods are known, which are called “projected mode” in the English-speaking world. Examples are “AppConnect Mode”, “Apple Carplay”, “Android Auto”, “Mirror Link” etc. In the screen mirroring method, the output of the wireless communication device (including portable wireless communication terminal device or the like) is made through a display device of the means of transport. Much of the logic runs in the wireless communication device, while the display and user inputs are made through the user interface of the means of transport. This requires the availability of a plurality of applications installed on the wireless communication device. At the same time, user analysis has so far only been carried out on the wireless communication device, as little information is available about the user steps and the operating behavior of the application in the means of transport.

One problem for manufacturers of means of transport is that when users have questions or are dissatisfied with the user interface in projected mode, they tend to hold the manufacturer of the means of transport responsible for inconvenience, although there is relatively little possibility from the manufacturer side to influence the functions performed in projected mode.

It is an object of the present invention to better determine the usage behavior of a user of a portable wireless communication device in a means of transport.

The above mentioned object is solved according to the invention by a method for evaluating the usage behavior of a user of a portable wireless communication device in a means of transport. The wireless communication device may be a smartphone, tablet, or similar. The means of transport may be, for example, a passenger car, van, truck, motorcycle, aircraft and/or watercraft. “Usage behavior” is understood to mean any interaction and the machine-evaluable steps and findings resulting from it with regard to the interaction of the user with the portable wireless communication terminal (in particular by means of the user interface of the means of transport). In a first step, the wireless communication device is operated in connection with the means of transport in a screen mirroring method (“projected mode”). For this purpose, the wireless communication device may be coupled to the means of transport and the “projected mode” may be started. Now the user may operate his wireless communication device via the user interface of the means of transport. A content originating from the wireless communication device is then analyzed by the means of transport using a graphical object recognition or detection algorithm and/or an acoustic pattern recognition or detection algorithm. In other words, the wireless communication device sends essentially consumer-ready content to the means of transport, wherein graphical content may be readily rendered content and acoustic content may be audio signals. In particular, the rendering of content originating from the wireless communication terminal device may have been started/initiated in response to a user input from the user via the user interface of the means of transport. Graphical content transmitted from the wireless communication terminal device to the means of transport via the projected mode may include, in particular, a graphical user interface (GUI) and/or video content. In particular, text chains/text modules may be contained as graphical elements in the content. According to the invention, the analysis of the content by the means of transport makes it possible to determine the usage behavior of the user. In other words, without logical interaction with the wireless communication device, the content originating from the same is analyzed phenomenologically and conclusions are drawn about the usage behavior by the means of transport. As a result, the usage behavior of the user and/or a plurality of users and especially problems/desires of users using the projected mode may be identified. Depending on this, the functionality of the screen mirroring methods/projected modes may be made more user-friendly. In addition, automatic assistance may be issued by the means of transport or reference may be made to functions located in the means of transport. All this leads to an improved user acceptance of the means of transport and especially its projected mode functionality.

The subclaims show preferred further developments of the invention.

Preferably, the content may include a component of a screen content and/or audio content output by the wireless communication device. For example, multimedia content consumed by the user via the projected mode may be detected. In particular, the joint analysis of a plurality of users, their applications and the operating scenarios that arise in connection with the same may reveal the need for modified properties of the projected mode and/or the integration of wireless communication devices into the means of transport. In addition, the consumer behavior of the user may be analyzed without a priori knowledge regarding the content originating from the wireless communication device. The more users carry out an operating step and/or an operating scenario, the more important its ergonomic design is. Therefore, the number of operating steps/operating scenarios corresponding to one another may automatically decide which adjustments to the projected mode of the means of transport should be given the highest priority in the further development of the same.

In particular, there is a need for action in the event that the usage behavior of the user indicates a need for support. For example, a dissatisfaction/disorientation of the user may be determined in projected mode. In response to the determination of the need for support, the means of transport may issue assistance associated with the need for support. For example, a help text may be output in text form or as spoken language to explain a function sought by the user, to confirm the absence of the function or to refer to a function of the means of transport which may be accessed, for example, via a user interface which is not in projected mode. This increases user acceptance and prevents the user from feeling left out.

In order to ensure the fastest possible and/or delay-free improvement of the user interface and/or the projected mode, it may be provided that a message representing the usage behavior and/or the analysis result is sent to a server by the means of transport. In other words, information about the usage behavior of the user in connection with the projected mode is collected and sent to the server using information technology. For example, the server may be operated by a manufacturer of the means of transport. In this way, the server collects all the information gathered in accordance with the invention and may make it available in an appropriate way to develop the projected mode and/or the means of transport in the best possible way. The message may be made anonymous before it is sent from the means of transport to the server. In other words, any personal information about the user and/or the means of transport that allows conclusions to be drawn with respect to the individual is removed. This does not mean that information useful for improvement (e.g. key data of the wireless communication device and/or the applications installed on it and/or the means of transport) is also removed. In particular, country-specific data protection regulations may be automatically taken into account.

According to a second aspect of the present invention, a server is proposed which is configured to receive the message originating from an aforementioned method according to the invention from a plurality of means of transport and to analyze the same in connection with each other. Here, the frequency, the urgency, the application of the wireless communication device used in projected mode, etc. may be used for clustering the information. For this purpose, the operating steps/information may be sorted and clustered by operating system/hardware/application/firmware etc. in order to best evaluate corresponding operating scenarios and hardware constellations. According to a third aspect of the present invention, a means of transport (e.g. a passenger car, van, truck, motorcycle, aircraft and/or watercraft) is proposed which has an information technology interface for operating a wireless communication device in a projected mode, so that the means of transport is configured to perform a method according to the first mentioned aspect of the invention. The information-technical coupling of the wireless communication device with the means of transport may be wired and wireless, for example. Especially in the case of wired integration of the wireless communication device into the on-board information network of the means of transport, the wireless communication device may also be supplied with energy via the interface. This does not mean that an e.g. inductive energy supply of the wireless communication device may not take place independently of the interface during this time. The features, combinations of features and the advantages of the second and third mentioned inventive aspect resulting from the same obviously result in such a way in accordance with the first inventive aspect that reference is made to the above explanations in order to avoid repetition.

Further details, features and advantages of the invention result from the following description and figures, in which:

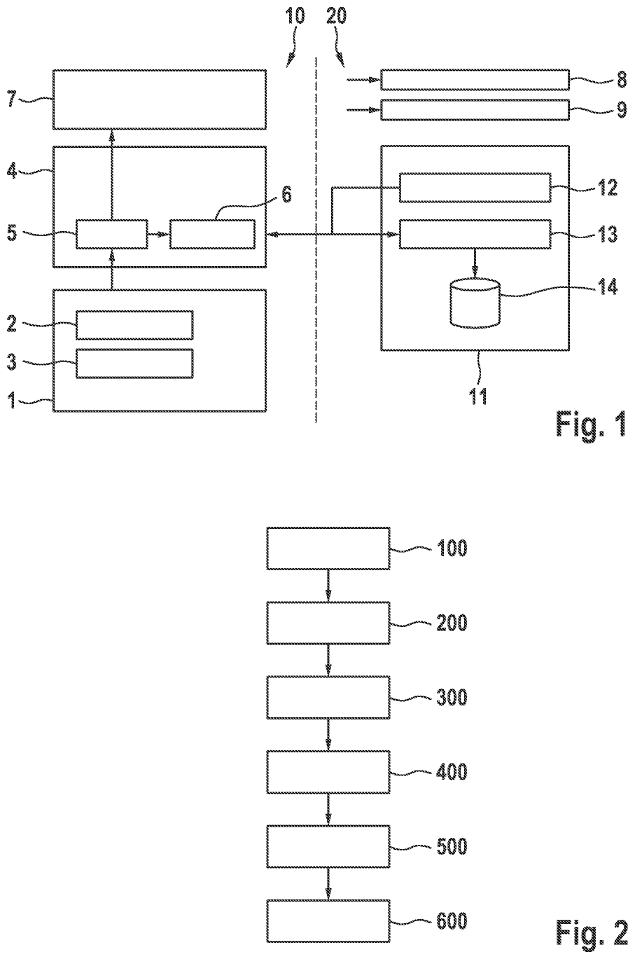

FIG. 1 shows a schematic representation of components of an embodiment of an inventive vehicle in the execution of an embodiment of an inventive method in connection with an embodiment of an inventive server; and

FIG. 2 shows a flow chart illustrating steps of an embodiment of an inventive method.

FIG. 1 shows an embodiment of a wireless communication device in the form of a smartphone 1, on which a first application 2 and a second application 3 are installed. The smartphone 1 is connected in terms of information technology to an evaluation unit in the form of a head unit 4 comprising a decoder 5 and an analysis module 6 of a passenger car 10 as a means of transport. The head unit 4 is in turn connected by information technology to a display device in the form of a display 7 of the passenger car 10. Whereas in the prior art applications 2, 3 generate and render audio and/or video data and then send the same to the decoder 5 and on to the display 7, the analysis module 6 is used to interpret the data rendered for output to the user in an inventive manner. In other words, the analysis module 6 determines information about what kind of data, what kind of operating steps and what kind of hardware, firmware and software are involved in the current projected mode and whether relevant scenarios exist. If this is the case, the analysis module sends data packages via the internet to an analysis server 11 in a backend 20, which catalogues the configuration in a configuration determination device 12, associates analysis data 13 and stores usage statistics in a database 14. For the further development of the projected mode and/or the car 10, developers may read the configuration and the analysis data 13 from the database 14 and view an associated video stream 8 and recognition patterns. If the analysis by the developers reveals a need to adapt the functionality of the user interface in the projected mode, a configuration-specific change may be requested and ordered (“Change Request”).

FIG. 2 shows steps of an embodiment of an inventive method for evaluating a usage behavior of a user of a portable wireless communication device in a means of transport. In step 100, the wireless communication device is coupled to the means of transport and is operated in connection with the same in a screen mirroring method/“Projected Mode”. In this process, consumer-ready multimedia content is sent from the wireless communication device to the means of transport. In step 200, a content originating from the wireless communication device is analyzed by the means of transport using a graphical object recognition algorithm. The analysis of the usage behavior in step 300 is only carried out after the explicit consent of the user, with the clear indication that the data is detected in anonymous form. In step 400 it is automatically detected that the usage behavior indicates a need for support of the user. This may be determined by comparatively long waiting times of the user between two inputs while at the same time the user's attention is directed to the user interface. In response to this, in step 500 an assistance associated with the need for support is issued by the means of transport. For example, a pop-up on a user interface of the means of transport may indicate that a function obviously sought by the user is not available in the projected mode and the user is given the choice of accessing the function directly via the means of transport and/or another user interface. In any case, in step 600 a message representing the usage behavior and/or the analysis result may be sent to the server by the means of transport. In other words, characteristic data and information about the used configuration which are important for the developer are determined and collected via the operating scenario in the projected mode. To improve the function and user comfort of the projected mode and/or means of transport, the information may be catalogued/structured and stored on the server and be made available to developers.

As a result, the present invention provides a starting point for improvements in means of transport offering a projected mode, improved integration of wireless communication devices into the on-board information network of a means of transport, more satisfied users and less distraction in road traffic.

### LIST OF REFERENCE NUMERALS

1 Smartphone

2, 3 Application

4 Head Unit

5 Decoder

6 Analysis module

7 Display

8 Video stream

9 Recognition pattern

10 Car

11 Analysis server

12 Configuration recognition device

13 Analysis data

14 Database

20 Backend

100-600 Method steps

1. A method for evaluating a usage behavior of a user of a portable wireless communication device in a means of transport comprising the steps of:
operating the wireless communication device in connection with the means of transport in a screen mirroring method, hereinafter referred to as “projected mode;”
analyzing a content originating from the wireless communication device using:
a graphical object recognition algorithm, and/or
an acoustic pattern recognition algorithm; and
determining the usage behavior of the user based on the analysis result.

2. The method according to claim 1, wherein the content comprises a part of:
a screen content, and/or
an audio content output by the wireless communication device.

3. The method according to claim 1, wherein the content comprises a character string, in particular a search string.

4. The method according to claim 1, further comprising:
automatically detecting that the usage behavior indicates a need for support by the user and, in response to that
outputting an assistance associated with the need for support by the means of transport.

5. The method according to claim 4, whereby the assistance recommends a function of the means of transport to the user.

6. The method according to claim 1, wherein the content comprises rendered content of a graphical user interface and/or multimedia reproduction of the wireless communication device.

7. The method according to claim 1, further comprising transmitting a message representing the usage behavior and/or the analysis result by the means of transport to a server.

8. A server configured to receive messages from a plurality of means of transport originating from a method according to claim 7 and to analyze the same in connection with each other.

9. A means of transport comprising an interface for operating a wireless communication device in a projected mode, wherein the means of transport is configured to execute a method according to claim 1.
